(19) United States
(12) Patent Application Publication
(10) Pub. No.: US 2007/0057042 A1
(43) Pub. Date: Mar. 15, 2007

(54) Electronic money settlement system and electronic money information storage medium

(75) Inventors: Junichi Yamagishi, Chuo-ku (JP); Sakae Ayabe, Isehara-shi (JP)

Correspondence Address: JORDAN AND HAMBURG LLP, 122 EAST 42ND STREET, SUITE 4000, NEW YORK, NY, 10168, US

(73) Assignee: Nihon Unica Corporation, Chuo-ku (JP)

(21) Appl. No.: 11/516,808

(22) Filed: Sep. 6, 2006

(30) Foreign Application Priority Data
Sep. 9, 2005 (JP) 2005-263049

(51) Int. Cl. G06K 5/00

(52) U.S. Cl. 235/380

(57) ABSTRACT

An electronic money settlement system for making settlement using an electronic money information storage medium 21 storing electronic money information, wherein the electronic money information storage medium 21 includes an electronic money storage area 27 storing the electronic money information, and a discount-rate storage 28 area storing a predetermined discount rate, and the discount rate is read from the discount-rate storage area 28, and according to the discount rate, settlement is made by the electronic money read from the electronic money storage area 27.

### BACKGROUND OF THE INVENTION

1. Field of the Invention

The present invention relates to an electronic money settlement system and an electronic money information storage medium such as a card-like medium.

2. Description of the Related Art

Electronic money settlement systems employ various cards such as prepaid cards and credit cards.

The prepaid card holds a predetermined amount of money, and when the money is entirely consumed, the prepaid card is discarded. Namely, the prepaid card is not reused. The credit card is settled through a bank when a certain amount of money is used with the credit card. The credit card has a problem of excessively spending money and a security problem.

Recently developed is an electronic money card such as an Edy card (registered trademark) which is a noncontact IC card storing electronic money information. When the electronic money card is used to purchase a commodity, the price of the commodity is subtracted for payment from the stored electronic money and the balance is written into the electronic money card.

The electronic money card is less problematic than the prepaid card and credit card and is safely reusable.

In such a system, when an electronic money card is used in a game arcade, in general, a user establishes initial deposit money at the entrance of the game arcade to take an electronic money card. The user then deposits an arbitrary amount of money to the electronic money card through a deposit machine. After the deposit, the user is allowed to play games within electronic money representative of deposit money of the electronic money card.

Accordingly, if the user consumes the electronic money entirely, the card is no longer needed. The user therefore returns the card for receiving the initial deposit at the time of leaving the game arcade. This cannot actively lead the user to come again to the game arcade, so that it is difficult to provide appropriate service.

The related art mentioned above is disclosed in, for example, Japanese Unexamined Patent Application Publication No. 2005-107734.

### SUMMARY OF THE INVENTION

An object of the present invention is to provide an electronic money settlement system capable of leading users to come again and provide the users with appropriate services.

In order to accomplish the object, an aspect of the present invention provides an electronic money settlement system for making settlement using an electronic money information storage medium storing electronic money information. The electronic money information storage medium includes an electronic money storage area storing the electronic money information and a discount-rate storage area storing a predetermined discount rate. The system reads the discount rate from the discount-rate storage area, and according to the discount rate, makes settlement by the electronic money read from the electronic money storage area.

According to this aspect of the present invention, the system provides each user with an electronic money card storing a predetermined discount rate, and it is possible to continue the possession of the electronic money card, thereby actively leading users to come again to a premise and the like.

Therefore, it is possible to provide users with more appropriate service through settlement with the discount rate.

### BRIEF DESCRIPTION OF THE DRAWINGS

FIG. 1 is a schematic diagram showing a game arcade to which an electronic money settlement system according to an embodiment of the present invention is applied;

FIG. 2 is a schematic diagram showing relationships among an electronic money card, and game machines, an administration unit, and a deposit/refund unit according to the embodiment; and

FIGS. 3 to 7 are system flowcharts according to the embodiment.

### DETAILED DESCRIPTION OF PREFERRED EMBODIMENT

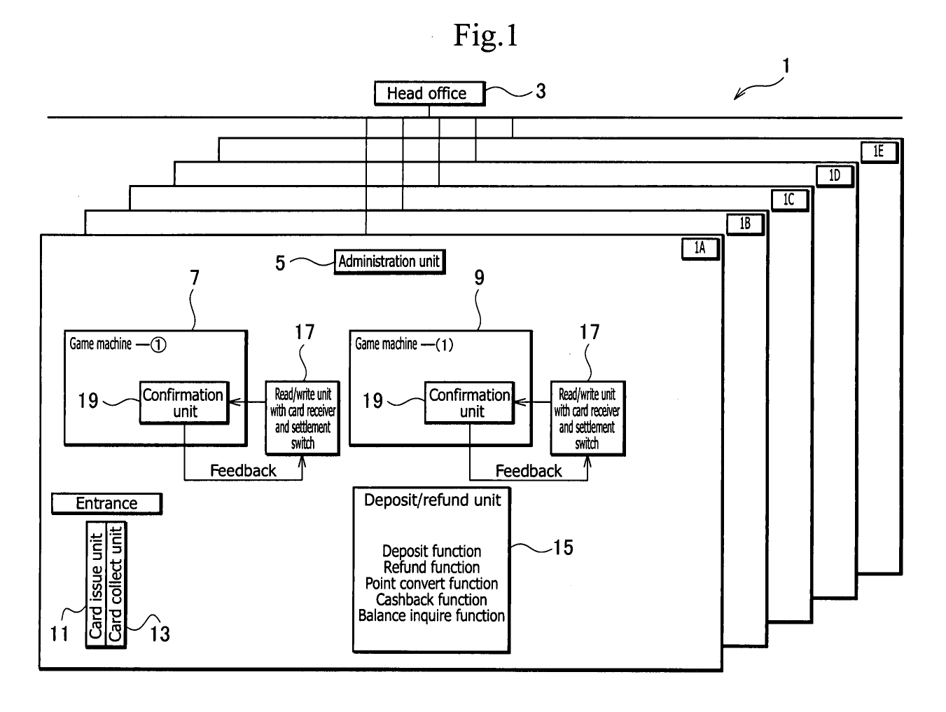

An electronic money settlement system according to an embodiment will be explained in detail. First, a configuration of the electronic money settlement system will be explained with reference to FIG. 1 that is a schematic diagram showing a game arcade as an amusement place to which an electronic money settlement system according to the embodiment of the present invention is applied.

As shown in FIG. 1, the electronic money settlement system is applied to, for example, each of a plurality of game arcades 1 represented with numerals 1A, 1B, 1C, 1D and 1E. The game arcades 1 (1A to 1E) are centrally managed by a head office 3. The game arcade 1 (1A to 1E) has the same configuration, and therefore, the game arcade 1 (1A) will be explained as a representative.

The game arcade 1 has an administration unit 5 that is accessible from the head office 3 so that the head office 3 can collect information of the sales of the game arcade 1 and manage the game arcade 1. The administration unit 5 has a read/write unit for reading and writing an electronic money card and a database and the like. The game arcade 1 includes a plurality of game machines 7, 9 and the like of the same type or various types, a card issue unit 11, a card collect unit 13, and a deposit/refund unit 15.

Each of the game machines 7, 9 . . . includes a reader/writer unit 17 for electronic money cards as electronic money information storage medium, and a confirmation unit 19 to determine whether or not the game machine must be started. The read/write unit 17 reads electronic money information or available points from an electronic money card, subtracts a charge for a game played with the game machine from the electronic money or points, and writes the balance or remaining points into the electronic money card. The confirmation unit 19 feeds back a signal indicative of an actual start of the relevant one of the game machines 7 or 9 . . . to the reader/writer unit 17. Upon feedback as a start signal, the reader/writer unit 17 starts accumulating fees for game play.

The card issue unit 11 and card collect unit 13 are arranged at the entrance of the game arcade 1A. When a user inserts initial deposit money into the card issue unit 11, the card issue unit 11 issues a blank electronic money card for the user. The card collect unit 13 collects the electronic money card when the user exits the game arcade 1A and returns the initial deposit money to the user.

The deposit/refund unit 15 has a deposit function, a refund function, a point convert function, a cashback function, and a balance inquire function. With the deposit function, when the user inserts the electronic money card and deposit money into the deposit/refund unit 15, the deposit/refund unit 15 inputs electronic money information representative of an amount of the deposit money into the electronic money card. With the refund function, the deposit/refund unit 15 returns money to the user if there is a balance in the electronic money information of the electronic money card and zeroes the balance in the electronic money information. With the balance inquire function, the deposit/refund unit 15 outputs a balance in the electronic money information of the electronic money card so that the user may recognize the balance. The point convert function and cashback function will be explained later. Cash-flow data of the deposit/refund unit 15 is transmitted to the administration unit 5 by wireless or wire.

At the entrance of the game arcade 1A, a user inserts initial deposit money into the card issue unit 11, and receives a blank electronic money card from the card issue unit 11. Thereafter, the user inserts the electronic money card and a certain amount of money into the deposit/refund unit 15, and receives from the deposit/refund unit 15 the electronic money card holding electronic money information representative of the inserted amount of money.

The user sets the electronic money card in the read/write unit 17 of a desired one of the game machines 7, 9, and the like so that the read/write unit 17 may read the electronic money information or available points from the electronic money card. The user may operate a start button on the game machine, to start a game. The confirmation unit 19 checks to see if the game has actually been started, and if started, feeds a confirmation signal back to the read/write unit 17. In response to the confirmation signal, the read/write unit 17 subtracts a charge for game play from the read electronic money information or available points sequentially and writes the balance as new electronic money information into the electronic money card, thereby settling the game charge.

Amounts of money and available points spent on the game machines of the game arcade 1A are transmitted to the administration unit 5 of the game arcade 1A by wireless or wire. The head office 3 accesses the administration unit 5 of each shop, to manage the sales and the like of the shops.

After a game play with the game machine, the user picks up the electronic money card that has already made a payment for the game machine as settlement for the game play and moves to another game machine or ends the game play.

When exiting the game arcade 1A, the user inserts the electronic money card into the card collect unit 13, so that the card collect unit 13 may collect the electronic money card. At this time, if the electronic money card has no pending charge or no balance, the card collect unit 13 refunds the initial deposit money for the electronic money card to the user.

Alternatively, the system may make the user carry the electronic money card with him or her to lead the user to visit the game arcade 1A again as described later.

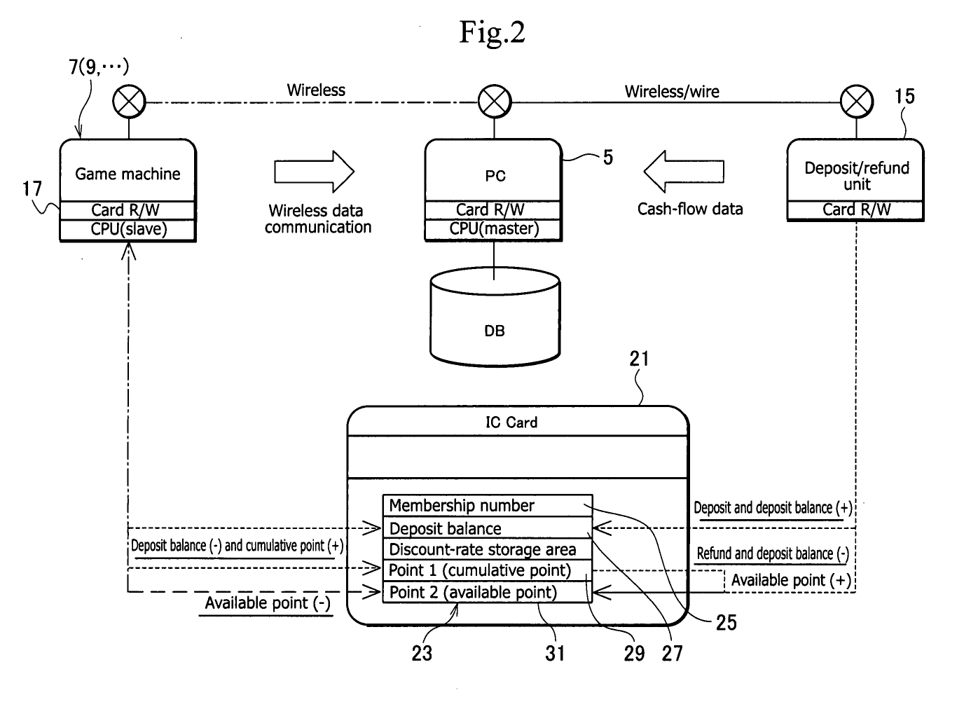

FIG. 2 is a schematic view showing relationships among the electronic money card, game machine, administration unit, and deposit/refund unit in the system of FIG. 1.

In FIG. 2, the electronic money card 21 is, for example, an IC card having an IC module provided with an IC contact.

The IC module has a memory 23. The memory 23 includes a membership number storage area 25, an electronic money storage area 27, a discount-rate storage area 28, a cumulative point storage area 29, and a point storage area 31.

The membership number storage area 25 stores a user's membership number. The electronic money storage area 27 stores electronic money information.

The discount-rate storage area 28 stores a predetermined discount rate. This discount rate is read from the discount-rate storage area 28 at the time of a payment settlement process, and the settlement process is performed on the basis of electronic money read from the electronic money storage area 27 according to the discount rate. As the discount rate, 10%, 20%, or others is stored in the discount-rate storage area 28. The discount rate may be set arbitrarily, and the discount rate may be changed by, for example, overwriting the discount-rate storage area 28.

Also, a discount rate stored in the discount-rate storage area 28 may be set according to an objective using the electronic money information. For example, discount rates may be set for game machines respectively, with a higher discount rate for popular machines and a lower discount rate for unpopular machines. In this case, a machine number assigned to each game machine may be read into the electronic money card 21, for example, thereby specifying the type of machine the user uses at the time of a settlement process.

The cumulative point storage area 29 serving as a cumulative information storage area cumulative points that are accumulated according to spending electronic money stored into the electronic money storage area 27. In the point storage unit 31 serving as a bonus storage unit, points representing bonus can be readably stored. The point storage area 31 as a bonus storage area stores readable points representative of available points as bonus.

The user is allowed to select whether the cumulative points are converted into available points as bonus to be stored in the point storage area 31 or into cashback money as other bonus according to a predetermined condition. This selection is carried out with the deposit/refund unit 15. Converting the cumulative points into available points to be stored in the point storage area 31 is carried out by the point convert function of the deposit/refund unit 15. Converting the cumulative points into cashback money is carried out by the cashback function of the deposit/refund unit 15. In this case, the deposit/refund unit 15 may pay money to the user according to cashback money

In the present embodiment, the predetermined condition may be that if the sum of the cumulative points exceeds a threshold, or any other.

The cumulative points in the cumulative point storage area 29 are increased whenever electronic money in the electronic money card is used. For example, a charge for a game machine is multiplied by a coefficient to calculate cumulative points to be added, or the charge itself is used as points and the cumulative points are increased by the points.

The coefficient may be differed depending on the game machines (7, 9, . . . ). For example, unpopular game machines may have higher coefficients to rapidly increase the cumulative points in the cumulative point storage area 29. Naturally, it is possible to set the same coefficient for all game machines.

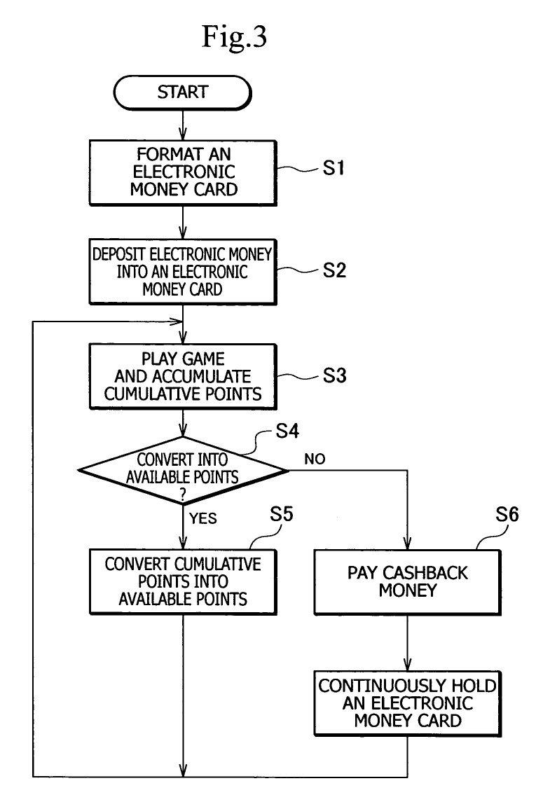

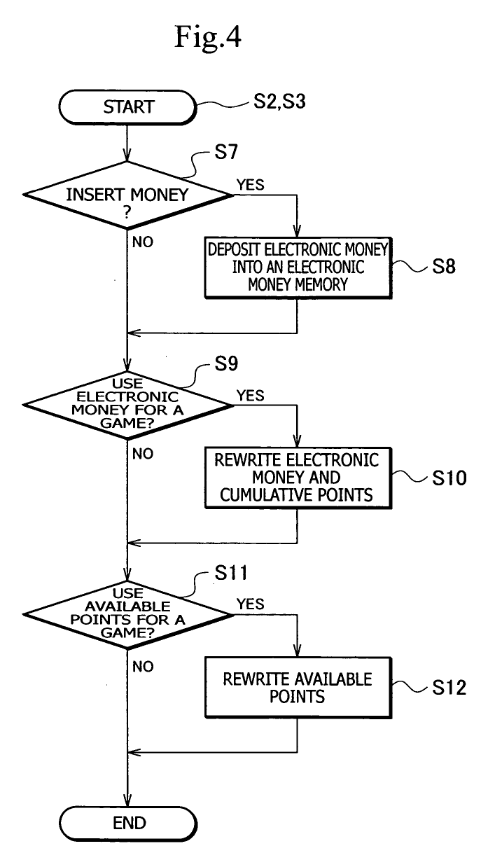

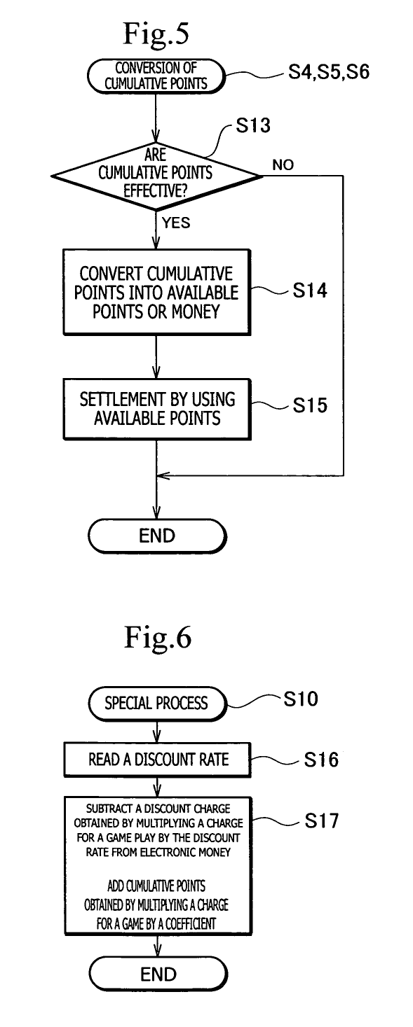

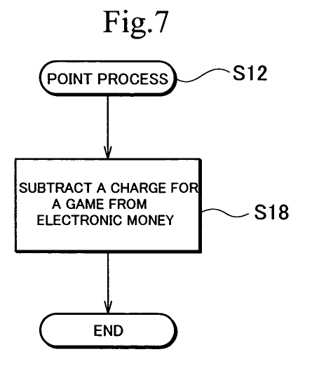

Operation of the electronic money settlement system will be explained with reference to FIGS. 3 to 7 in which FIG. 3 is a flowchart of the entire process, FIG. 4 is a flowchart showing the details of steps S2 and S3 in FIG. 3, FIG. 5 is a flowchart showing the details of steps S4, S5, and S6 in FIG. 3, FIG. 6 is a flowchart showing the details of step S10 in FIG. 4, FIG. 7 is a flowchart showing the details of step S12 in FIG. 4.

In the flowchart in FIG. 3, an electronic money card 21 is inserted into the deposit/refund unit 15, thereby process of step S1 is started.

In step S1, the inserted electronic money card 21 is formatted, and the entire process proceeds to step S2.

In step S2, a user of the electronic money card 21 inserts an arbitrary amount of money into the deposit/refund unit 15 to be stored in the electronic money card 21 as electronic money information. Thereafter, the entire process proceeds to step S2.

In step S3, the user insets an IC contact of the electronic money card 21 into a read/write field generated by a read/write unit 17 of a game machine 7, 9 or the like, so that a game play is started and cumulative points are accumulated. Thereafter, the entire process proceeds to step S2.

In step S4, the system determines whether or not cumulative points are converted into available points. In this process, a determination is varied based on operation of the deposit/refund unit 15 by the user. If the cumulative points are converted, the entire process proceeds to step S5. Otherwise, the entire process proceeds to step S6.

In step S5, the cumulative points are converted into available points. If a game is played again, the entire process is repeated from step S3.

In step S6, the cumulative points are converted into cashback money and the amount of cashback money is paid to the user. When a game is played again, the entire process is repeated from step S3.

The processes of steps S2 and S3 of FIG. 3 will be explained with reference to FIG. 4 in detail.

In step S7 of FIG. 4, the deposit/refund unit 15 determines whether or not money is inserted thereinto. If inserted, the deposit/refund unit 15 decides to make a request for a deposit of electronic money, and the process of FIG. 4 proceeds to step S8. If not inserted, the deposit/refund unit 15 decides to not make a request for a deposit of electronic money, and the process of FIG. 4 proceeds to step S9.

In step S8, the deposit/refund unit 15 input electronic money representative of the amount of the inserted money into the electronic money storage area 27 of the electronic money card 21. At the same time, the deposit/refund unit 15 stores a membership number of the user into the membership number memory 25. This completes step S8, and the process of FIG. 4 proceeds to step S9.

In step S9, the selected game machine determines whether or not the user selects use of electronic money for a game at the read/write unit 17. If the user selects use of electronic money, the process of FIG. 4 proceeds to step S10. If the user does not select use of electronic money, the process of FIG. 4 proceeds to step S11.

In step S10, the electronic money information stored in the electronic money card 21 is read from the electronic money storage area 27 by the read/write unit 17. After game play, a balance obtained by subtracting a charge for the game play from the read electronic money information is input to the read/write unit 17. The read/write unit 17 writes the balance as new electronic money information into the electronic money card 21 when the electronic money card 21 is brought into the read/write field again. At the same time, cumulative points according to the amount of the charge are written into the cumulative point storage area 29 to be added.

In step S11, the selected game machine determines whether or not the user selects use of available points for a game at the read/write unit 17. If the user selects use of available points, the process of FIG. 4 proceeds to step S12. If the user does not select use of available points, the process is terminated. Thereafter, the entire process returns to step S3 of FIG. 3.

In step S12, the available points stored in the electronic money card 21 are read from the point storage area 31 by the read/write unit 17. After a game play, a balance obtained by subtracting points corresponding to a charge for the game play from the read available points is input to the read/write unit 17. The read/write unit 17 writes the balance as new available points into the point storage area 31 of the electronic money card 21 when the electronic money card 21 is brought into the read/write field again.

Steps S4 to S6 will be explained with reference to FIG. 5 in detail.

In step S13, the deposit/refund unit 15 determines whether or not the cumulative points stored in the cumulative point storage area 29 of the electronic money card 21 are effective. Namely, if the cumulative points exceed to the threshold, it decides that the cumulative points are effective. This completes step S13, and the process proceeds to step S14. If the cumulative points do not exceed to the threshold, it decides that the cumulative points are not effective. This terminates the process.

In step S14, the effective cumulative points are selectively converted into bonuses. If the user selects the available points as the bonus, the deposit/refund machine 15 converts the effective cumulative points into available points and rewrites the available points stored in the point memory 31 so as to add the converted available points. If the user selects cashback as the bonus, the deposit/refund machine 15 converts the effective cumulative points into the money at a predetermined realization rate to be refunded to the user.

In step S15, when the user brings the electronic money card 21 into a read/write field of a read/write part 17 of a game machine when the user plays games again, the user can make settlement by using the converted available points.

Step S10 in FIG. 4 will be explained with reference to FIG. 6.

In step S16, the predetermined discount rate is read from the discount-rate storage area 28 of the electronic money card 21 by the read/write unit 17 together with electronic money information.

In step S17, after the game play, when the user brings the electronic money card 21 into the read/write field of the reader/writer unit 17, the read/write unit 17 subtracts a discount charge obtained by multiplying a charge for the game play by the discount rate from the read electronic money information. The balance after the subtraction is written in the electronic money storage area 27 of the electronic money card 21 as new electronic money information. In this way, the settlement using the electronic money for the game play is completed.

If the discount rate is set higher for unpopular machines and the discount rate is set zero for popular machine, it may raise operation rates of unpopular machines can be increased.

The point process in step S12 is performed in a manner shown in the flowchart of FIG. 7.

In step S18, after the game play, when the user brings the electronic money card 21 into the read/write field of the reader/writer unit 17, the read/write unit 17 subtracts points corresponding the charge for the game play from the read available points. The balance after the subtraction is written in the point storage area 31 of the electronic money card 21. In this way, the settlement using the available points for the game play is completed.

As mentioned above, the electronic money card 21 having the electronic money storage area 27 in which the electronic money information is stored readably, and the discount-rate storage area 28 storing a predetermined discount rate. The discount rate is read from the discount-rate storage area 28, and according to the discount rate, settlement is made by the electronic money read from the electronic money storage area 27. Thus, the system provides each user with an electronic money card 21 storing a predetermined discount rate, and it is possible to continue the possession of the electronic money card 2 1, thereby actively leading users to come again to the game arcade.

For this reason, the system can provide users with more appropriate services through settlement with the discount rate.

Although the system is applied to settlement for use of game machines in a game arcade in the embodiment, it may also be applied to purchase of goods, for example.

Also, although the electronic money information storage medium is applied an electronic money card, it may also be applied to a cellular phone.

What is claimed is:

1. An electronic money settlement system for making settlement using an electronic money information storage medium storing electronic money information, wherein
the electronic money information storage medium includes an electronic money storage area storing the electronic money information, and a discount-rate storage area storing a predetermined discount rate, and
the discount rate is read from the discount-rate storage area, and according to the discount rate, settlement is made by the electronic money read from the electronic money storage area.

2. The electronic money settlement system of claim 1, wherein
the discount-rate storage area sets the discount rate according to an objective using the electronic money information.

3. An electronic money information storage medium, comprising:
an electronic money storage area storing electronic money information and a discount-rate storage area storing a predetermined discount rate, wherein
the discount rate is read from the discount-rate storage area, and according to the discount rate, settlement is made by the electronic money stored in the electronic money storage area.
